(19) United States
(12) Patent Application Publication
(10) Pub. No.: US 2008/0311415 A1
(43) Pub. Date: Dec. 18, 2008

(54) Use of a Latex Composition Having at Least One Ureido Function For Adhering to Wood

(75) Inventors: Jean-Christophe Castaing, Burlington, NJ (US); William Bett, Paris (FR); Jean-Noel Bousseau, Loyettes (FR)

Correspondence Address: OBLON, SPIVAK, MCCLELLAND MAIER & NEUSTADT, P.C., 1940 DUKE STREET, ALEXANDRIA, VA, 22314, US

(73) Assignee: LAPEYRE, Courbevoie (FR)

(21) Appl. No.: 12/065,097

(22) PCT Filed: Aug. 30, 2006
(86) PCT No.: PCT/FR2006/002008

§ 371 Date: Aug. 27, 2008

(30) Foreign Application Priority Data
Aug. 30, 2005 (FR) 0508868

(51) Int. Cl. C08L 33/04; C08L 33/02; C08L 33/18; C08L 33/10; C08L 9/00; C08L 31/04; C08L 33/12

(52) U.S. Cl. 428/537.1; 526/317.1; 526/287; 526/295; 526/328; 526/263; 526/264; 526/329.7; 526/319; 524/552; 524/560; 524/563

(57) ABSTRACT

The present invention concerns the use, in the surface treatment of waterproofed wood, of an aqueous dispersion comprising at least one latex obtained by emulsion polymerization of a mixture of monomers comprising at least one acrylic monomer B comprising at least one ureido function.

The present invention relates to the lignocellulosic material industry, especially to the field of the surface treatment of wood. In particular, it describes an aqueous composition comprising an acrylic latex carrying at least one ureido function and the use of such a composition in the treatment of wood, more particularly wood which has been treated with a fatty substance.

Natural wood is used as a material in the construction industry to fabricate parts intended in some cases to be exposed to outdoor conditions: it is used, for example, in the fabrication of doors, shutters or door and window frames.

Such parts are never left untreated. They are generally coated with a surface coating which may comprise several layers (a primary coat, a stain, a finishing coat) which function to embellish and protect the wood against ageing due to exposure to rain and UV radiation.

Wood may also undergo a prior bulk treatment, generally with a fatty substance, to augment the durability by limiting the quantity of water taken up by the wood in contact with moisture.

Water has a deleterious effect as it encourages the development of xylophage species and it results in a dimensional modification of the wood (the wood “swells”), causing cracks to form.

We shall make reference below to woods which have undergone a bulk treatment with a fatty substance as “waterproofed” wood, such as the thermo-oiled wood developed by Oléobois, wood treated in accordance with French patent FR-A-2 801 241 describing a process developed by CIRAD, and wood described in international patent applications WO-A-05/007369, WO-A-03/049913 and WO-A-04/033171. Particular attention is drawn to the wood developed by Lapeyre as described in WO-A-03/084723.

The Applicant is particularly interested in the primary coat deposited directly in contact with the wood, making exclusive reference to binders deposited in the aqueous phase (as they have advantages in terms of low toxicity and lesser impact on the environment compared with binders deposited from solvents).

This coat must adhere to the wood in a durable manner so that the various protective and decorative functions of the coating are maintained long-term.

The adhesion of such a coat is difficult to guarantee if the wood has undergone a prior treatment to render it hydrophobic.

In general, it is difficult to deposit a binder in an aqueous phase on a natural or compressed “hydrophobic” wood without exposure to dewetting phenomena.

Water has a tendency to “bead” on treated wood and the coating film shrinks partially before it has time to dry, which damages its aesthetic and protective qualities. Further, once the film is dry, a “low energy” type adhesion to the support must be guaranteed (which means that on the molecular scale, establishing bonds other than Van Der Waals bonds, which are not very adhesive, to the treated wood and the coat is difficult).

Further, the “hydrophobic” treatment may exhibit exudation phenomena, which have the disadvantage of forming a non-adhesive liquid layer between the coat and the wood.

Similarly, for a wood which has not been bulk-treated by a “hydrophobic” treatment, it is difficult to guarantee good adhesion under damp conditions for two reasons. Firstly, since the wood is hydrophilic, water molecules can reach the interface between the coat and the wood more easily and break certain of the bonds which provide adhesion. This phenomenon is particularly true for binders deposited from an aqueous phase (which are stabilized by hydrophilic molecules, which remain sensitive to water even in the dry coat). Further, the dimensional variation of the wood in the presence of water induces lateral stresses within the coating which may cause cohesion loss phenomena.

The Applicant has discovered that the problems discussed above and others can be solved by using a latex carrying at least one ureido function.

The Applicant has discovered that an acrylic latex containing at least one ureido function has enhanced adhesion to lignocellulosic materials, in particular waterproofed wood, even under damp conditions.

The term “waterproofed wood” as used here means a compressed or natural raw wood which has undergone at least one treatment intended to render the external surface of the wood hydrophobic, in particular by application of a synthetic fatty substance, of vegetable or animal origin.

The solution which the Applicant has discovered is based on the use, in the surface treatment of waterproofed wood, of an aqueous dispersion comprising at least one latex obtained by emulsion polymerization of a mixture of monomers comprising at least one monomer comprising at least one ureido function.

More precisely, in a first aspect the present invention concerns the use, in the surface treatment of waterproofed wood, of an aqueous dispersion comprising at least one latex obtained by emulsion polymerization of a mixture of monomers comprising at least one acrylic monomer comprising at least one ureido function.

The term “ureido function” as used here means a function with general formula (Iₐ):

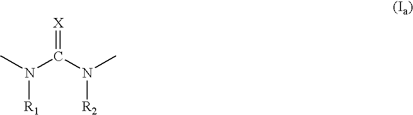

where:

X is O or S; and

R₁ and R₂ independently represent hydrogen, a linear or branched alkyl group containing 1 to 6 carbon atoms, a cycloalkyl group containing 5 to 15 carbon atoms such as cyclohexyl, an aryl group containing 5 to 15 carbon atoms such as phenyl, or an aralkyl group containing 6 to 12 carbon atoms such as methylbenzyl, these groups optionally being substituted with one or more groups selected from halogen, amine, hydroxyl and carboxyl.

The ureido function is termed “cyclic” when R₁ and R₂ are connected to each other via an alkylene group containing 2 or 3 carbon atoms, optionally carrying one or more alkyl groups containing 1 to 4 carbon atoms, especially methyl, propyl or butyl, such as ethylene, propylene or trimethylene.

The term “acrylic monomer” means a monomer comprising the function with formula (I_{b}):

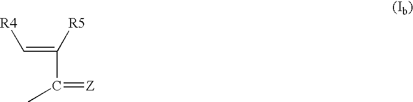

where:
R₄ and R₅ independently represent hydrogen, a linear or branched alkyl group containing 1 to 6 carbon atoms, especially methyl, propyl or butyl, a cycloalkyl group containing 5 to 8 carbon atoms, or an aryl or aralkyl group containing 6 to 12 carbon atoms, optionally carrying an alkyl group containing 1 to 4 carbon atoms, in particular phenyl, methylphenyl, benzyl or methylbenzyl;
Z is O or S, preferably O.

In particular, the acrylic monomer comprises acrylic monomers and methacrylic monomers. Particular examples which can be cited are (meth)acrylic acids, (meth)acrylic esters and (meth)acrylonitrile.

Examples of acrylic monomers carrying at least one ureido function which can be used to prepare the latex which may be cited are those having the following general formula (I_{c}):

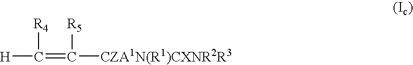

where:
R₄ and R₅ independently represent a hydrogen, a linear or branched alkyl group containing 1 to 6 carbon atoms, especially methyl, propyl or butyl, a cycloalkyl group containing 5 to 8 carbon atoms, or an aryl or aralkyl group containing 6 to 12 carbon atoms, optionally carrying an alkyl group containing 1 to 4 carbon atoms, in particular phenyl, methylphenyl, benzyl or methylbenzyl;
A¹ is an alkylene group containing 2 or 3 carbon atoms, such as —CH₂—CH₂— or —CH(CH₃)CH₂—, oxyalkylene containing 2 or 3 carbon atoms, such as —O—CH₂—CH₂— or —O—CH(CH₃)CH₂—, or aminoalkylene containing 2 or 3 carbon atoms, such as —N—CH₂—CH₂— or —N—CH(CH₃)CH₂—;
R¹ and R² independently represent hydrogen, a linear or branched alkyl group containing 1 to 6 carbon atoms, a cycloalkyl group containing 5 to 15 carbon atoms such as cyclohexyl, an aryl group containing 5 to 15 carbon atoms such as phenyl, or an aralkyl group containing 6 to 12 carbon atoms such as methylbenzyl or benzyl. They may be connected together, for example via a linear alkylene group containing 2 to 4 carbon atoms, such as ethylene, propylene or trimethylene, optionally carrying one or more alkyl groups containing 1 to 4 carbon atoms, especially methyl, propyl or butyl;
R³ is hydrogen or an alkyl group containing 1 to 8 carbon atoms, optionally interrupted by or substituted with a heteroatom, especially an oxygen; and
Z and X are independently O or S, preferably O.

In a preferred implementation, the (meth)acrylic monomers carrying at least one ureido function are those having the following general formula (I_{d}):

H₂C═CRZA¹N(R¹)CXNR²R³ (I_{d})

in which:
R is a methyl group;
A₁, R₁, R₂, R₃, Z and X have the meanings given above.

Particular examples of monomers carrying at least one ureido function which may be cited are those comprising the following cycle (Iₑ):

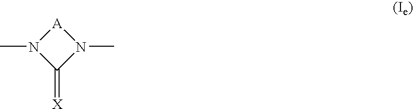

in which:
A represents an alkylene group containing 2 to 4 carbon atoms, such as ethylene, propylene or trimethylene, optionally carrying an alkyl group containing 1 to 4 carbon atoms, especially methyl, propyl or butyl;
X is O or S, preferably O.

One of the nitrogen atoms in the cycle (Iₑ) is connected to the group carrying the polymerizable ethylenic bond while the other nitrogen atom is connected to a hydrogen or to a group such as a methylol group, an alkoxymethyl group or to an alkyl group containing 1 to 8 carbon atoms.

In accordance with the invention, the preferred cycle is:

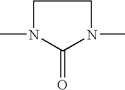

Preferred examples of acrylic monomers carrying at least one cyclic ureido function which may be cited are those corresponding to the following formula (I_{f}):

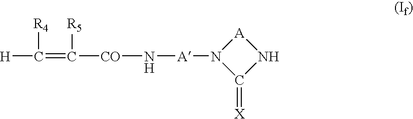

in which:
R₄ and R₅ have the meanings given above;
A and A′ represent an alkylene group containing 2 to 4 carbon atoms, such as ethylene, propylene or trimethylene, optionally carrying an alkyl group containing 1 to 4 carbon atoms, especially methyl, propyl or butyl;
X is O or S, preferably O.

Examples of monomers with the above formula which may be cited are beta-ureido ethyl vinyl ether, beta-ureido ethyl vinyl sulphide, beta-thioureido ethyl vinyl ether, and N-(beta-ureido ethyl)acrylamide also termed methacrylamide ethyl ethylene urea and hereinafter denoted monomer B1 with formula (I_{g}):

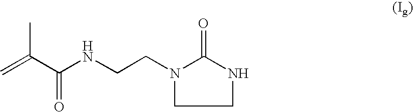

To obtain the latex used in the invention, a mixture of monomers is used which may comprise:
a—60% to 99% by weight of the total monomer weight of at least one monomer A selected from styrene and its derivatives; butadiene; chloroprene; (meth)acrylic esters such as methyl methacrylate, ethyl acrylate, butyl acrylate, 2-ethylhexyl acrylate; (meth)acrylic acids such as acrylic acid or methacrylic acid; maleic anhydride; vinyl esters such as vinyl acetate or vinyl versatate; vinyl nitriles and sulphonated monomers such as sodium or potassium 1-allyloxy-2-hydroxypropylsulphonate (COPS), sodium or potassium allylsulphonate (MTAS), or sodium or potassium acrylamidomethylpropanesulphonate (AMPS); and
   b—0.1% to 40% by weight of the total monomer weight of at least one monomer B selected from (meth)acrylic monomers carrying at least one ureido function, especially methacrylamide ethyl ethylene urea.

The ethylenically unsaturated monomer A in accordance with the invention is any monomer which is polymerizable by a radical emulsion pathway using techniques which are well known to the skilled person. Particular examples of these monomers which may be cited are those corresponding to the following formula (IIa):

CXdX′d(=CVd−CV′d)ₜ=CH₂ (IIa)

where:
Xd, X′d, which may be identical or different, represent H, an alkyl group or a halogen;
Vd, V′d, which may be identical or different, represent H, a halogen or a group R, OR, OCOR, NHCOH, OH, NH₂, NHR, N(R)₂, (R)₂N⁺O⁻, NHCOR, CO₂H, CO₂R, CN, CONH₂, CONHR ou CONR₂, in which R, which may or may not be identical, are selected from alkyl, aryl, aralkyl, alkaryl, alkene and organosilyl groups, optionally perfluorinated and optionally substituted with one or more carbonyl, carboxyl, epoxy, hydroxyl, alkoxy, amino, halogen ou sulphonic groups, or in the form of the salts thereof;
t is 0 or 1.

In a particular implementation of the invention, the monomers employed are preferably hydrophobic monomers.

Particular illustrations of hydrophobic monomers which may be cited are styrene or its derivatives, butadiene, chloroprene, (meth)acrylic esters, vinyl esters and vinyl nitriles.

The term “(meth)acrylic esters” means esters of acrylic acid and methacrylic acid with hydrogenated or fluorinated C₁-C₁₂ alcohols, preferably C₁-C₈.

More particularly, the vinyl nitriles include those containing 3 to 12 carbon atoms, in particular acrylonitrile and methacrylonitrile. It should be noted that the styrene may be completely or partially replaced by derivatives such as alpha-methylstyrene or vinyltoluene.

Particular other ethylenically unsaturated monomers which may be used alone or as a mixture or which are copolymerizable with the above monomers are as follows:
vinyl carboxylic acid esters such as vinyl acetate or vinyl versatate;
vinyl halides;
vinylamine amides;
ethylenically unsaturated monomers comprising a secondary, tertiary or quaternary amino group or a heterocyclic group containing nitrogen. It is also possible to use zwitterionic monomers such as sulphopropyl (dimethyl)aminopropyl acrylate.

It should be noted that it is possible, for example, to use hydrophilic monomers, such as:
ethylenically unsaturated mono- and di-carboxylic acids;
mono-alkyl esters of dicarboxylic acids of the type cited with alkanols preferably containing 1 to 4 carbon atoms, and their N-substituted derivatives;
unsaturated carboxylic acid amides;
ethylenic monomers comprising a sulphonic acid group and its alkali or ammonium salts;
unsaturated carboxylic acid amides, such as acrylamide, methacrylamide, N-methylolacrylamide or N-methylolmethacrylamide or N-acrylamides.

In a preferred implementation, ethylenically unsaturated monomers may be cited which correspond to the following formula (IIb):

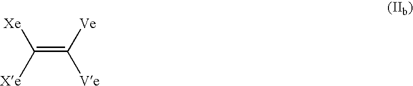

where:
Xe and X′e, which may be identical or different, represent hydrogen, an alkyl group containing 1 to 4 carbon atoms or a halogen, especially F, Cl or Br;
Ve and V′e, which may be identical or different, represent hydrogen, a halogen, especially F, Br or Cl, or a group R, CH₂OR, OR, OCOR, NHCOH, OH, NH₂, NHR, N(R)₂, (R)₂N⁺O⁻, NHCOR, CO₂H, CO₂R, CN, CONH₂, CONHR or CONR₂, in which groups R, which may or may not be identical, are selected from alkyl groups containing 1 to 12 carbon atoms, aryl groups, especially a phenyl, aralkyl, alkaryl, alkene or organosilyl group, optionally perfluorinated and optionally substituted with one or more carbonyl, carboxyl, epoxy, hydroxyl, alkoxy, amino, halogen ou sulphonic groups, or in the form of their salts.

In another implementation, Xe and Ve may be connected via an alkylene group containing 2 or 3 carbon atoms, such as ethylene, propylene or trimethylene, possibly substituted with a carbonyl group.

Preferably, the ethylenically unsaturated monomer may be selected from styrene or its derivatives: butadiene; chloroprene; (meth)acrylic esters such as methyl methacrylate, ethyl acrylate, butyl acrylate, 2-ethylhexyl acrylate; (meth)acrylic acids such as acrylic acid, methacrylic acid; maleic anhydride; vinyl esters such as vinyl acetate, vinyl versatate; vinyl nitriles and sulphonated monomers such as sodium or potassium 1-allyloxy-2-hydroxypropylsulphonate (COPS), sodium or potassium allylsulphonate (MTAS), or sodium or potassium acrylamidomethylpropanesulphonate (AMPS).

Monomer B is advantageously employed in an amount in the range 0.5% to 20%, in particular in the range 1% to 10% by weight of the total weight of monomers to be polymerized.

The latex of the invention may be obtained using suitable emulsion polymerization techniques which are well known to the skilled person, as will be described below.

The polymerization reaction of the invention takes place in the presence of a radical polymerization initiator.

This may be selected from initiators which are conventionally used in radical polymerization. They may, for example, be one of the following initiators:
hydrogen peroxides such as: tertiary-butyl hydroperoxide, cumene hydroperoxide, t-butyl-peroxyacetate, t-butylperoxybenzoate, t-butylperoxyoctoate, t-butylperoxyneodecanoate, t-butylperoxyisobutyrate, lauroyl peroxide, t-amylperoxypivalate, t-butylperoxypivalate, dicumyl peroxide, benzoyl peroxide, potassium persulphate or ammonium persulphate;
azo compounds such as: 2-2′-azobis(isobutyronitrile), 2,2′-azobis(2-butanenitrile), 4,4′-azobis(4-pentanoic acid), 1,1′-azobis(cyclohexane-carbonitrile), 2-(t-butylazo)-2-cyanopropane, 2,2′-azobis[2-methyl-N-(1,1)-bis(hydroxymethyl)-2-hydroxyethyl]propionamide, 2,2′-azobis[2-methyl-N-hydroxyethyl]propionamide, 2,2′-azobis(N,N′-dimethyleneisobutyramidine) dichloride, 2,2′-azobis(2-amidinopropane) dichloride, 2,2′-azobis(N,N′-dimethyleneisobutyramide), 2,2′-azobis(2-methyl-N-[1,1-bis (hydroxymethyl)-2-hydroxyethyl]propionamide), 2,2′-azobis(2-methyl-N-[1,1-bis(hydroxymethyl)ethyl]propionamide), 2,2′-azobis[2-methyl-N-(2-hydroxyethyl)propionamide] or 2,2′-azobis(isobutyramide) dihydrate,
   redox systems comprising combinations such as:
      mixtures of hydrogen or alkyl peroxide, peresters, percarbonates and the like and any iron salt or titanous salt, zinc formaldehyde sulphoxylate or sodium formaldehyde sulphoxylate, and reducing sugars;
      alkali metal or ammonium persulphates, perborate ou perchlorate in association with an alkali metal bisulphite such as sodium metabisulphite, and reducing sugars;
      alkali metal persulphates in association with an arylphosphonic acid such as benzene phosphonic acid and the like, and reducing sugars.

The polymerization reaction is carried out conventionally.

It is carried out in the presence of a non-ionic or anionic surfactant selected from alkoxylated mono-, di- or trialkylphenols, alkoxylated mono-, di- or tristyrylphenols, alkoxylated fatty alcohols, alkali or ammonium salts of C₈-C₁₂ alkyl sulphates, sulphated alkoxylated fatty alcohol semi-esters, C₁₂-C₁₈ alkyl ester sulphonates, etc.

The polymerization temperature is also conventional. By way of illustration, the temperature is in the range 50° C. to 120° C., more particularly in the range 70° C. to 100° C.

In general, the polymer or binder essentially constituted by latex represents 30% to 60% by weight of the total latex weight.

The latex of the invention has a minimum film-forming temperature in the range 0° C. to 80° C., preferably in the range 0° C. to 40° C., and a glass transition temperature in the range −20° C. to 90° C., preferably in the range 10° C. to 50° C.

The surface treatment may be carried out on compressed or natural raw waterproofed wood. The waterproofed wood is obtained from raw wood by a bulk treatment with a fatty substance, especially a synthetic fatty substance or a fatty substance of vegetable or animal origin.

The waterproofed wood may be obtained from raw natural wood, for example using the process described in WO-A-96/038275, which consists of impregnating the wood with a vegetable oil and/or any fatty substance of animal or mineral origin. The following in particular can be cited in this regard: saturated, mono- or poly-unsaturated fatty alcohols and acids and derivatives thereof, such as esters or anhydrides, for example maleic anhydride. The treatment may be that described, for example, in WO-A-03/084723, in which the treatment is carried out by grafting with a mixed anhydride apart from the mixed anhydride of acetic/benzoic acid, preferably between 100° C. and 140° C. The mixed anhydride may, for example, be prepared from an acid chloride and a carboxylic ester, an acid chloride and a carboxylic acid salt or from an anhydride of a linear carboxylic acid and a fatty acid. Mention may also be made of the process described in WO-A-03/049913 cited above.

The raw wood which may be treated in accordance with the invention is generally selected from beech, pine, sipo, oak, para-para (jacaranda), meranti, curupixa, eucalyptus and tauari.

The skilled person would know how to define and add to the composition of the invention any ingredient or additive necessary to produce it, dependent upon the selected application and wood.

Thus, the composition of the invention may, for example, comprise a plasticizer, a silane and an anti-UV agent, in the following proportions by weight:

a. latex, 89% to 100%;

b. plasticizer, 0 to 5%;

c. silane, 0 to 1%;

d. anti-UV, 0 to 5%.

In general, the “plasticizer” is a liquid compound which is partially or slightly soluble in water, intended to reduce the glass transition temperature of the latex. In particular, Texanol® (trimethyl hydroxypentyl isobutyrate) sold by Eastman may be cited.

In general, the “anti-UV” compound is a mineral or organic compound characterized by good transparency to visible radiation and strong UV radiation absorption. An example which may be cited is that of cerium oxide nanoparticles with a diameter of about 10 nm.

The silane may in particular reinforce adhesion to the waterproofed wood in the short term.

Preferably, the silane is a compound with the following general formula:

R_{c}—[Si(R_{d})(ORₑ)(OR_{f})]ₘ
R_{c} represents a linear, branched or cyclic alkyl or alkene group containing 1 to 30 carbon atoms, optionally substituted with and/or interrupted by one or more heteroatom(s), especially an oxygen, a sulphur or a nitrogen, or an aryl or aralkyl group containing 5 to 30 carbon atoms, optionally substituted with and/or interrupted by one or more heteroatom(s), especially an oxygen, a sulphur or a nitrogen, or substituted with a carbonyl group, a carboxyl group, an amino, alkylamino, amide, nitrile or epoxy group or a group comprising a vinyl or acrylic function, especially methacrylic, or a ureido group;
R_{d} represents a hydrogen, ORₑ, OR_{f} or a linear or branched alkyl group containing 1 to 5 carbon atoms, optionally substituted with and/or interrupted by one or more heteroatoms, especially an oxygen or a nitrogen;
Rₑ and R_{f} independently represent a hydrogen or a linear or branched alkyl group containing 1 to 5 carbon atoms;

m is in the range 1 to 3.

In particular, the silane employed may be γ-glycidoxypropyl trimethoxysilane.

More particularly, the silane of the invention may be selected from:
octyltriethoxysilane;
methyl triethoxysilane;
methyl trimethoxysilane;
tris-[3-(trimethoxysilyl)propyl] isocyanurate;
γ-mercaptopropyl trimethoxysilane;
bis-(3-[triethoxysilyl]propyl)polysulphide;
bis-(3-[triethoxysilyl]propyl)disulphide;
γ-aminopropyl triethoxysilane;
γ-aminopropyl trimethoxysilane;
N-(β-aminoethyl)-γ-aminopropyl trimethoxysilane;
bis-[γ-(trimethoxysilyl)propyl]amine;
N-(β-aminoethyl)-γ-aminopropyl methyldimethoxysilane;
N-phenyl-γ-aminopropyl trimethoxysilane;
N-ethyl-γ-aminoisobutyl trimethoxysilane;
4-amino-3,3-dimethylbutyl trimethoxysilane;
4-amino-3,3-dimethylbutylmethyl dimethoxysilane;
γ-ureidopropyl trialkoxysilane;
γ-ureidopropyl trimethoxysilane;
γ-isocyanatopropyl triethoxysilane;
γ-isocyanatopropyl trimethoxysilane;
β-(3,4-epoxycyclohexyl)ethyl trimethoxysilane;
γ-glycidoxypropyl trimethoxysilane;
β-(3,4-e poxycyclohexyl)ethyl triethoxysilane;
γ-glycidoxypropyl methyldiethoxysilane;
vinyl triethoxysilane;
vinyl trimethoxysilane;
vinyl tris-(2-methoxyethoxy)silane;
vinyl methyldimethoxysilane;
vinyl triisopropoxysilane;
γ-methacryloxypropyl trimethoxysilane;
γ-methacryloxypropyl triisopropoxysilane; and
γ-methacryloxypropyl triethoxysilane.

In a second aspect, the present invention concerns a lignocellulosic material, preferably a waterproofed wood, obtained using the aqueous dispersion of the invention.

The following examples illustrate the invention without limiting its scope. They show that, compared with reference samples synthesized under the same conditions but without the monomer B1, adhesion after the wetting and drying cycles is reinforced with the latexes of the invention.

### EXAMPLES

### Example 1

### Synthesis of Latexes in Accordance with the Invention

Latex A (in accordance with the invention): 3000 g of water, 53.5 g of anionic surfactant and 100 g of a sulphonated copolymerizable monomer were charged into a stainless steel reactor with a volume of 25 l. At the same time, an emulsion was prepared by mixing 3840 g of water, 100 g of the same anionic surfactant and 100 g of acrylic acid, 160 g of monomer B1, 4550 g of methyl methacrylate and 3450 g of 2-ethylhexyl acrylate. 7.5% of this emulsion was placed in the reactor. The reactor was then heated to 80° C. The remainder of the emulsion and an aqueous persulphate solution (5 g of ammonium persulphate per 500 g of water) were supplied over 6.5 h. Following these introductions, the temperature was kept at 80° C. for 1 h, then the latex was cooled. Its pH was brought to 8 by adding ammonia.

Latex A (reference): The same procedure and the same monomer compositions were used, apart from monomer B1 which was left out.

Latex B (in accordance with the invention): 3000 g of water, 53.5 g of anionic surfactant and 100 g of a sulphonated copolymerizable monomer were charged into a stainless steel reactor with a volume of 25 l. At the same time, an emulsion was prepared by mixing 3840 g of water, 100 g of the same anionic surfactant and 100 g of acrylic acid, 160 g of monomer B1, 4000 g of methyl methacrylate and 4000 g of 2-ethylhexyl acrylate. 7.5% of this emulsion was placed in the reactor. The reactor was then heated to 80° C. The remainder of the emulsion and an aqueous persulphate solution (5 g of ammonium persulphate per 500 g of water) were supplied over 6.5 h. Following these introductions, the temperature was kept at 80° C. for 1 h, then the latex was cooled. Its pH was brought to 8 by adding ammonia.

Latex B (reference): The same procedure and the same monomer compositions were used, apart from monomer B1 which was left out.

### Example 2

The experiments which were carried out were aimed at quantifying the adhesion to wood, even under damp conditions, of coats of varnish containing the latexes of the invention by comparison with latexes not containing a ureido group.

The following woods were used:
oak;
sipo;
pine;
beech;
natural wood treated with a fatty substance, denoted waterproofed wood.

As mentioned above, the treatment may have been that described, for example, in WO-A-03/084723 in which the treatment is carried out by grafting with a mixed anhydride comprising hydrocarbon chains other than the mixed acetic acid/benzoic acid anhydride.

Adhesion was evaluated using a cross-cut test: the film was cut into a cross using a cutter. A strip of adhesive tape, applied then withdrawn, allowed non-adhesive portions of the coating to be lifted. The result was evaluated using International standard ISO 2409 of November 1994.

The adhesion tests were carried out after conditioning the planks of wood for different periods in a saline mist type chamber. The saline mist chamber was initially an accelerated ageing chamber to evaluate the corrosion of metallic materials. The operating conditions for this chamber were as follows: the test temperature was 50° C.; inside the chamber, the samples were subjected to a mist of saline water (the NaCl concentration was adjusted to 5.3 g/l), the samples were laid down flat, with the face carrying the coating to be tested facing upwards.

Further, only one face of the test wood pieces had been treated; this accentuated the water swelling phenomenon; water entered via the five other unpainted surfaces.

The term “film” means that the suspension of binder (per se) was applied in a thickness of 300 μm (wet thickness) then dried.

The term “varnish” means that the binder was included in the following formulation (Table 1):

TABLE 1

| | Weight | | |
|---|---|---|---|
| CONSTITUENTS | (g) | Function | Supplier |
| Latex, A, B or C (SC = 48%) | 56.98 | binder | |

Commence stirring, add pre-mixture

| | | | |
|---|---|---|---|
| TEXANOL | 2.71 | Coalescence | EASTMANN |
| | | agent | |
| WATER | 1.80 | | |
| ACRYSOL RM-2020 | 1.80 | Associative PU | ROHM & |
| (SC = 20%) | | thickening | HAAS |
| | | agent | |
| BYK 024 (SC = 95%) | 0.18 | Anti-foaming | BYK |
| | | agent | CHEMIE |
| RHODOLINE DP 1210 | 0.32 | Dispersing | RHODIA |
| (SC = 40%) | | agent | |
| ACEMATT OK 412 | 2.15 | Matting agent | DEGUSSA |
| WATER | 20.50 | | |
| AMMONIA 20% | 0.09 | | |
| PROPYLENE GLYCOL | 4.51 | | |
| WOODOL 100 ES | 2.28 | Fungicide | |
| RHODIGARD W200 | 4.96 | Mineral anti- | RHODIA |
| (optional) | | UV agent | |
| SILQUEST ® Silane A-187 | 1.00 | Coupling agent | UNION |
| (optional) | | | CHEMICALS |
| ACRYSOL RM-8 W | 0.72 | Associative PU | ROHM & |
| | | thickening | HAAS |
| | | agent | |
| TOTAL | 100.00 | | |

In the examples below, the result is a whole number in the range 0 to 5, with 5 denoting poor latex adhesion and 0 denoting better adhesion thereof.

The characteristics of the latexes of the examples are given in Table 2 below:

TABLE 2

| | |
|---|---|
| latex A (invention) | acrylic latex with MFFT = 20° C. with B1 |
| latex A (reference) | acrylic latex with MFFT = 20° C. without B1 |
| latex B (invention) | acrylic latex with MFFT = 0° C. with B1 |
| latex B (reference) | acrylic latex with MFFT = 0° C. without B1 |
| latex C (reference) | LS5000 (acrylic nanolatex) |

### Example 2.1

The films of latex or varnish were applied without adding supplemental additives.

The results are shown in Table 3 below:

TABLE 3

| | Drying conditions | | | | |
|---|---|---|---|---|---|
| | 18 h, 55% rh, 23° C. | | | 7 d, 100% | 17 d, 100% |
| Treatment with a film | | Appear- | Water | rh, 35° C. | rh, 35° C. |
| or a varnish | Cross-cut | ance | angle | Cross-cut | Cross-cut |
| App° film latex A (invention) | 3 | flush | 57 | 0 | 0 |
| (+5% Texanol) | | | | | |
| App° film latex B | 0 | dewetting | 68 | 1 | 1 |
| (reference) | | | | | |
| App° film latex C | 0 | dewetting | 51 | 0 | 0 |
| (reference) (+2% Texanol) | | | | | |
| App° vernis latex B | 3 | flush | 68 | 2 | 3 |
| (reference) | | | | | |
| App° vernis latex A | 0 | flush | 78 | 0 | 0 |
| (invention) | | | | | |

These results highlight the importance of latex A of the invention. Latex C also performed well but exhibited problems with dewetting on application.

To highlight the importance, if any, of the monomer “monomer B1”, the following comparative tests were carried out on different types of wood.

### Example 2.2

The results are shown in Tables 4 to 6 (as a function of the period of ageing in the saline mist chamber).

The latexes were compared as a function of the presence of monomer B1 and in combination with other agents which could reinforce the durability of the film (silane or mineral anti-UV).

These results highlight the advantage as regards dry adhesion and wet adhesion on various woods of latexes containing monomers B1. Adding the epoxy silane reinforces adhesion, in particular on waterproofed wood and in the short term.

TABLE 4

| | | | | | Anti | Dry adhesion at t = 0 | | | | |
|---|---|---|---|---|---|---|---|---|---|---|
| Latex | | | Plasticizer | Silane | UV | Waterproofed | | | | |
| Latex | B1 | % | Texanol | W78 | RW200 | wood | beech | pine | sipo | oak |
| latex A | no | 95 | 5 | 0 | 0 | 2 | 3 | 2 | 2 | 0 |
| (reference) | | | | | | | | | | |
| latex A | no | 94 | 5 | 1 | 0 | 0 | 0 | 1 | 1 | 0 |
| (reference) | | | | | | | | | | |
| latex A | no | 89 | 5 | 1 | 5 | 0 | 0 | 1 | 1 | 0 |
| (reference) | | | | | | | | | | |
| latex A | yes | 95 | 5 | 0 | 0 | 2 | 0 | 0 | 0 | 0 |
| (invention) | | | | | | | | | | |
| latex A | yes | 94 | 5 | 1 | 0 | 0 | 0 | 0 | 0 | 0 |
| (invention) | | | | | | | | | | |
| latex A | yes | 89 | 5 | 1 | 5 | 0 | 0 | 0 | 0 | 0 |
| (invention) | | | | | | | | | | |
| latex B | no | 100 | 0 | 0 | 0 | 0 | 0 | 0 | 0 | 0 |
| (reference) | | | | | | | | | | |
| latex B | no | 99 | 0 | 1 | 0 | 0 | 0 | 0 | 0 | 0 |
| (reference) | | | | | | | | | | |
| latex B | no | 94 | 0 | 1 | 5 | 0 | 0 | 0 | 0 | 0 |
| (reference) | | | | | | | | | | |
| latex B | yes | 100 | 0 | 0 | 0 | 0 | 0 | 0 | 0 | 0 |
| (invention) | | | | | | | | | | |
| latex B | yes | 99 | 0 | 1 | 0 | 0 | 0 | 0 | 0 | 0 |
| (invention) | | | | | | | | | | |
| latex B | yes | 94 | 0 | 1 | 5 | 0 | 0 | 0 | 0 | 0 |
| (invention) | | | | | | | | | | |

TABLE 5

| | | | | | | Adhesion after 17 h | | | | |
|---|---|---|---|---|---|---|---|---|---|---|
| | | | | | Anti | in saline mist | | | | |
| Latex | | | Plasticizer | Silane | UV | Waterproofed | | | | |
| Latex | B1 | % | Texanol | W78 | RW200 | wood | beech | pine | sipo | oak |
| latex A | no | 95 | 5 | 0 | 0 | 2 | 5 | 5 | 0 | 0 |
| (reference) | | | | | | | | | | |
| latex A | no | 94 | 5 | 1 | 0 | 0 | 5 | 5 | 0 | 0 |
| (reference) | | | | | | | | | | |
| latex A | no | 89 | 5 | 1 | 5 | 0 | 5 | 5 | 0 | 0 |
| (reference) | | | | | | | | | | |
| latex A | yes | 95 | 5 | 0 | 0 | 2 | 0 | 2 | 0 | 0 |
| (invention) | | | | | | | | | | |
| latex A | yes | 94 | 5 | 1 | 0 | 0 | 0 | 1 | 0 | 0 |
| (invention) | | | | | | | | | | |
| latex A | yes | 89 | 5 | 1 | 5 | 0 | 0 | 0 | 0 | 0 |
| (invention) | | | | | | | | | | |
| latex B | no | 100 | 0 | 0 | 0 | 0 | 5 | 5 | 0 | 0 |
| (reference) | | | | | | | | | | |
| latex B | no | 99 | 0 | 1 | 0 | 0 | 5 | 5 | 0 | 0 |
| (reference) | | | | | | | | | | |
| latex B | no | 94 | 0 | 1 | 5 | 0 | 5 | 5 | 0 | 0 |
| (reference) | | | | | | | | | | |
| latex B | yes | 100 | 0 | 0 | 0 | 0 | 5 | 5 | 0 | 0 |
| (invention) | | | | | | | | | | |
| latex B | yes | 99 | 0 | 1 | 0 | 0 | 1 | 0 | 0 | 0 |
| (invention) | | | | | | | | | | |
| latex B | yes | 94 | 0 | 1 | 5 | 0 | 0 | 0 | 0 | 0 |
| (invention) | | | | | | | | | | |

TABLE 6

| | | | | | | Adhesion after 12 d | | | | |
|---|---|---|---|---|---|---|---|---|---|---|
| | | | | | Anti | in saline mist | | | | |
| Latex | | | Plasticizer | Silane | UV | Waterproofed | | | | |
| Latex | B1 | % | Texanol | W78 | RW200 | wood | beech | pine | sipo | oak |
| latex A | no | 95 | 5 | 0 | 0 | 5 | 5 | 5 | 5 | 3 |
| (reference) | | | | | | | | | | |
| latex A | no | 94 | 5 | 1 | 0 | 0 | 5 | 5 | 5 | 3 |
| (reference) | | | | | | | | | | |
| latex A | no | 89 | 5 | 1 | 5 | 0 | 5 | 5 | 5 | 3 |
| (reference) | | | | | | | | | | |
| latex A | yes | 95 | 5 | 0 | 0 | 0 | 0 | 0 | 0 | 0 |
| (invention) | | | | | | | | | | |
| latex A | yes | 94 | 5 | 1 | 0 | 0 | 0 | 0 | 0 | 0 |
| (invention) | | | | | | | | | | |
| latex A | yes | 89 | 5 | 1 | 5 | 0 | 0 | 0 | 0 | 0 |
| (invention) | | | | | | | | | | |
| latex B | no | 100 | 0 | 0 | 0 | 3 | 5 | 5 | 5 | 3 |
| (reference) | | | | | | | | | | |
| latex B | no | 99 | 0 | 1 | 0 | 0 | 5 | 5 | 1 | 0 |
| (reference) | | | | | | | | | | |
| latex B | no | 94 | 0 | 1 | 5 | 0 | 5 | 5 | 0 | 0 |
| (reference) | | | | | | | | | | |
| latex B | yes | 100 | 0 | 0 | 0 | 0 | 5 | 3 | 0 | 0 |
| (invention) | | | | | | | | | | |
| latex B | yes | 99 | 0 | 1 | 0 | 0 | 0 | 0 | 0 | 0 |
| (invention) | | | | | | | | | | |
| latex B | yes | 94 | 0 | 1 | 5 | 0 | 0 | 0 | 0 | 0 |
| (invention) | | | | | | | | | | |

The presence in the latex of a monomer carrying at least one ureido function is of advantage when the waterproofed wood is subjected to prolonged damp conditions.

1. The method of using an aqueous dispersion comprising at least one latex obtained by emulsion polymerization of a mixture of monomers comprising at least one acrylic monomer B comprising at least one ureido function in the surface treatment of waterproofed wood.

2. The method as claimed in claim 1, wherein the mixture of monomers comprises at least one monomer A selected from styrene or its derivatives; butadiene; chloroprene; (meth)acrylic esters; (meth)acrylic acids; maleic anhydride; vinyl esters; vinyl nitrites and sulphonated monomers.

3. The method as claimed in claim 2, wherein monomer A is selected from: methyl methacrylate, ethyl acrylate, butyl acrylate, 2-ethylhexyl acrylate; acrylic acid; methacrylic acid; vinyl acetate; vinyl versatate; sodium or potassium 1-allyloxy-2-hydroxypropylsulphonate (COPS), sodium or potassium allylsulphonate (MTAS), and sodium or potassium acrylamidomethyl propanesulphonate (AMPS).

4. The method as claimed in claim 1, wherein acrylic monomer B carrying the ureido functions has general formula I_{f}: 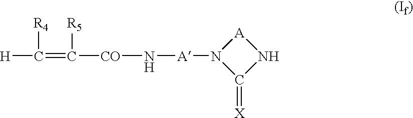
in which:
R₄ and R₅ independently represent a hydrogen, a linear or branched alkyl group containing 1 to 6 carbon atoms, especially methyl, propyl or butyl, a cycloalkyl group containing 5 to 8 carbon atoms, or an aryl or aralkyl group containing 6 to 12 carbon atoms, optionally carrying an alkyl group containing 1 to 4 carbon atoms, in particular phenyl, methylphenyl, benzyl or methylbenzyl;
A and A′ independently represent an alkylene group containing 2 to 4 carbon atoms, optionally carrying an alkyl group containing 1 to 4 carbon atoms;
X is an oxygen or a sulphur atom.

5. The method as claimed in claim 4, wherein acrylic monomer B carrying at least one ureido function has formula I_{f} in which R₄ and R₅ respectively represent a hydrogen and a methyl group and A and A′ independently represent an ethylene, propylene, isopropylene or trimethylene group.

6. The method as claimed in claim 4, wherein acrylic monomer B carrying at least one ureido function is methacrylamide ethyl ethylene urea with formula (I_{g}):

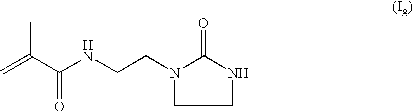

7. The method as claimed in claim 2, wherein monomer A represents 60% to 99% by weight of the total monomer mixture weight.

8. The method of using an aqueous dispersion comprising at least one latex obtained by emulsion polymerization of a mixture of monomers comprising:
a—60% to 99% by weight of the total monomer mixture weight of at least one monomer A selected from styrene and its derivatives: butadiene; chloroprene; (meth)acrylic esters such as methyl methacrylate, ethyl acrylate, butyl acrylate, 2-ethylhexyl acrylate; (meth)acrylic acids such as acrylic acid, methacrylic acid; maleic anhydride; vinyl esters such as vinyl acetate, vinyl versatate; or vinyl nitrites and sulphonated monomers; and
b—0.1% to 40% by weight of the total monomer mixture weight of at least one monomer B selected from (meth)acrylic monomers carrying ureido functions in the surface treatment of wood.

9. The method as claimed in claim 8, wherein monomer B carrying at least one ureido function represents 0.1% to 40%, by weight of the total monomer mixture weight.

10. The method as claimed in claim 8, wherein the latex has a minimum film-forming temperature (MFFT) in the range 0° C. to 80° C.

11. The method as claimed in claim 8, wherein the latex has a glass transition temperature in the range −20° C. to 90° C.

12. The method as claimed in claim 8, wherein the wood to be treated is a compressed or natural raw wood.

13. The method as claimed in claim 12, wherein the raw wood is selected from beech, pine, sipo, oak, para-para (jacaranda), meranti, curupixa, eucalyptus and tauari.

14. The method as claimed in claim 12, wherein the waterproofed wood is obtained from raw wood by bulk treatment using a synthetic fatty substance of vegetable origin or a fatty substance of animal origin.

15. The method as claimed in claim 8, wherein the composition further includes a plasticizer, a silane and an anti-UV agent.

16. The method as claimed in claim 15, wherein the mixture of latex, plasticizer, silane and anti-UV agent has the following proportions by weight:
latex, 89% to 100%;
plasticizer, 0 to 5%;
silane, 0 to 1%;
anti-UV, 0 to 5%.

17. The method as claimed in claim 15, wherein the silane is γ-glycidoxypropyl trimethoxysilane.

18. A waterproofed wood obtained using an aqueous dispersion as claimed in claim 1.

19. The method of claim 9, wherein monomer B carrying one ureido function represents 0.5% to 20% by weight of the total monomer mixture weight.

20. The method of claim 10, wherein the latex has a minimum film-forming temperature in the range 0° C. to 40° C.

21. The method of claim 11, wherein the glass transition temperature is in the range of 10° C. to 50° C.
